(19) United States
(12) Patent Application Publication
(10) Pub. No.: US 2026/0281074 A1
(43) Pub. Date: Sep. 17, 2026

(54) Time-Based Message Actions

(71) Applicant: Yahoo Assets LLC, New York, NY (US)

(72) Inventors: Mohit Goenka, Santa Clara, CA (US); Manmada R Nallagonda, Mountain House, CA (US)

(21) Appl. No.: 19/078,148

(22) Filed: Mar. 12, 2025

(51) Int. Cl. H04L 51/42; G06Q 10/107; H04L 51/18

(52) U.S. Cl. CPC H04L 51/42; G06Q 10/107; H04L 51/18

(57) ABSTRACT

One or more computing devices and/or methods for time-based message actions are provided. Time-based message action rules are defined for a message account. A time-based action rule specifics that an action is to be performed upon messages, having a message type, after expiration of a timespan. Message content of a message is analyzed to determine a detected message type of the message. In response to the detected message type of the message matching the message type of the message action rule, a determination is made as to whether the timespan as expired for the message. If the timespan has expired, then the action is performed for the message.

### BACKGROUND

Many message service providers implement message management functions to help users manage their message accounts. For example, a message service provider may implement a spam message detection function that automatically identifies and stores potential spam type messages into a spam folder. The message service provider may implement a clutter message detection function that automatically identifies and stores potential clutter type messages into a cluster folder. The message service provider may provide users with the ability to define rules used to block messages from certain senders, such as the creation of a block sender or domain list.

### SUMMARY

In accordance with the present disclosure, one or more computing devices and/or methods for time-based message actions are provided. Time-based message action rules may be defined for a message account of a user. The message account may relate to emails, text messages, instant messages, multimedia messages, social media messages, audio messages, video messages, or any other form of communication. A time-based message action rule may specify that an action is to be performed upon messages, having a particular message type, after expiration of a timespan. The action may specify that a message is to be deleted, moved to a particular folder, a notification is to be generated, a log entry is to be created, or any other computer implemented action. The message type may be a one-time password message, a coupon message, a promotional message, a password reset message, a confidential message, a message controlled by a retention policy (e.g., a healthcare or financial message that is regulated by a retention policy where the message is to be retained in a read only state for 3 years and then can be deleted), a time sensitive message where information within the message may become irrelevant after a timespan, or any other type of message. The timespan may be set for hours, days, weeks, etc. The timespan may be set to correspond to the occurrence of an event such as the conclusion of a sporting event, an election, a concert, an account being closed, a user unsubscribing, etc.

Messages may be periodically analyzed by a scanner using the time-based message action rules to determine whether any messages satisfy the criteria of the time-based message action rules. For example, a message type of a message may be determined based upon message content of the message (e.g., the message includes keywords or patterns such as “coupon,” “expires,” “password,” “limited time”). If the message type of the message matches a time-based message action rule (e.g., a sign-in attempt message), then a determined expiration time or timestamp associated with the message may be compared to the timespan of the time-based message action rule. If the expiration time or timestamp indicates that the message is older than the timespan (e.g., the message is deemed to be an expired message), then the action may be performed upon the message such as to delete the message or move the message to a particular folder. Time-based message actions may also be performed based upon send-specified expirations that may be defined through message header tags (e.g., a sender of a coupon message may specify that the coupon message is to be deleted within 7 days of receipt).

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for time-based message actions.

FIG. 5 is a component block diagram illustrating an example system for time-based message actions.

FIG. 6 is a component block diagram illustrating an example system for hosting a message management interface for managing time-based message actions.

FIG. 7 is a component block diagram illustrating an example system for hosting a message management interface for managing time-based message actions.

FIG. 8A is a component block diagram illustrating an example system implementing a time-based message action for a message.

FIG. 8B is a component block diagram illustrating an example system implementing a time-based message action for a message based upon a sender specified expiration.

FIG. 9 is a component block diagram illustrating an example system for hosting a message system through a message client.

FIG. 10 is a component block diagram illustrating an example system for hosting a message system through a message server.

FIG. 11 is a component block diagram illustrating an example system for hosting a message system through a cloud service.

FIG. 12 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### Computing Scenario

The following provides a discussion of some types of computing scenarios in which the disclosed subject matter may be utilized and/or implemented.

### Networking

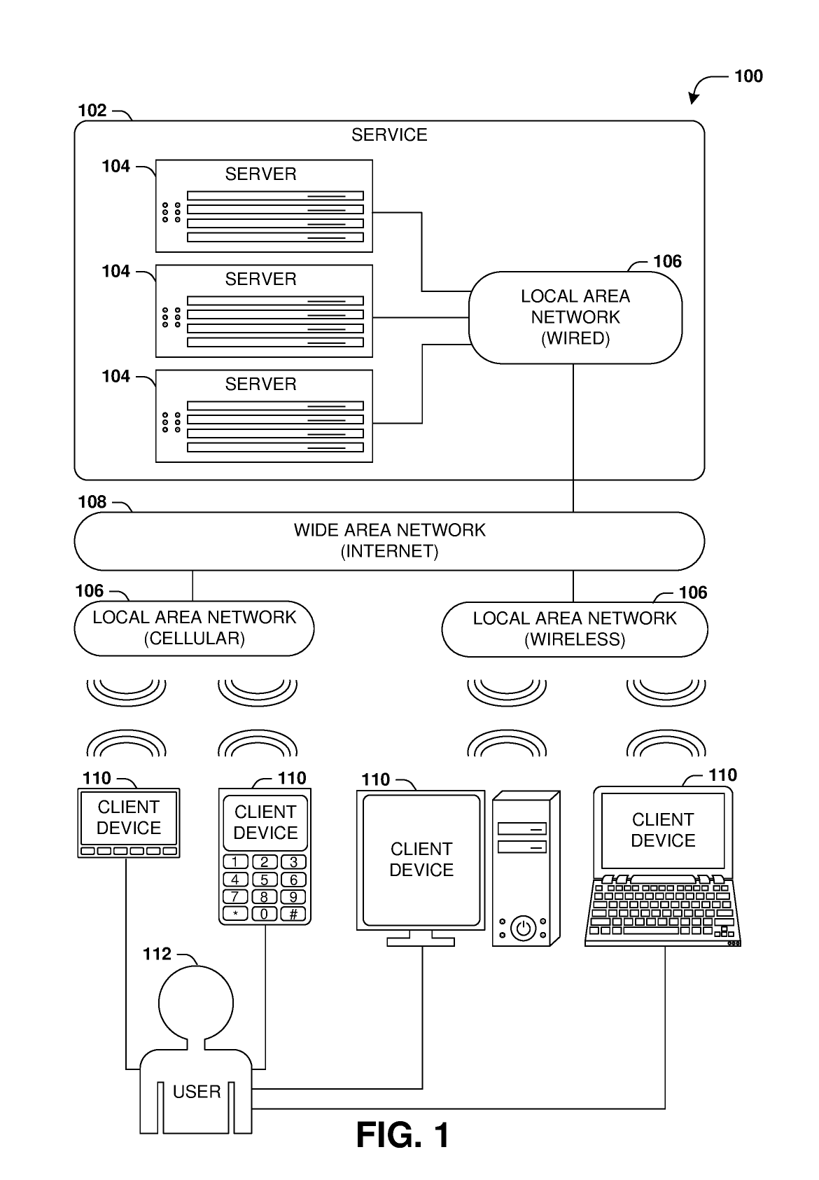

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user’s home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### Server Configuration

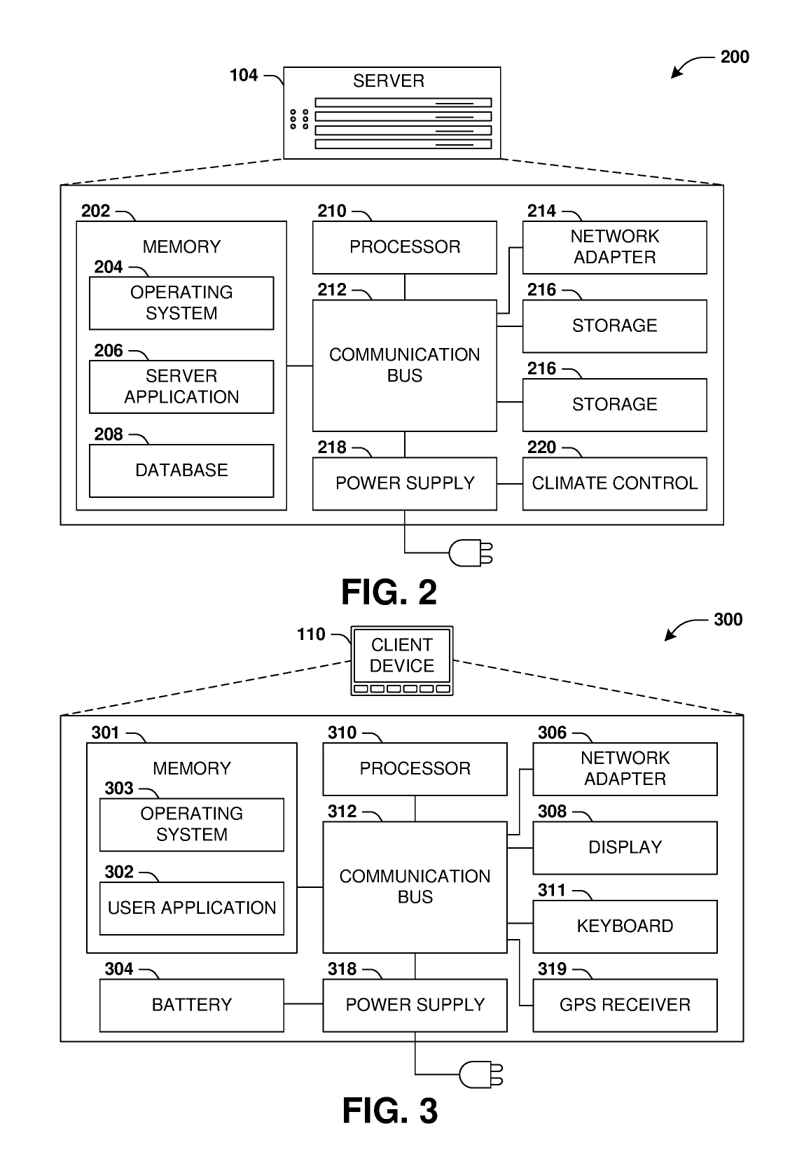

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### Client Device Configuration

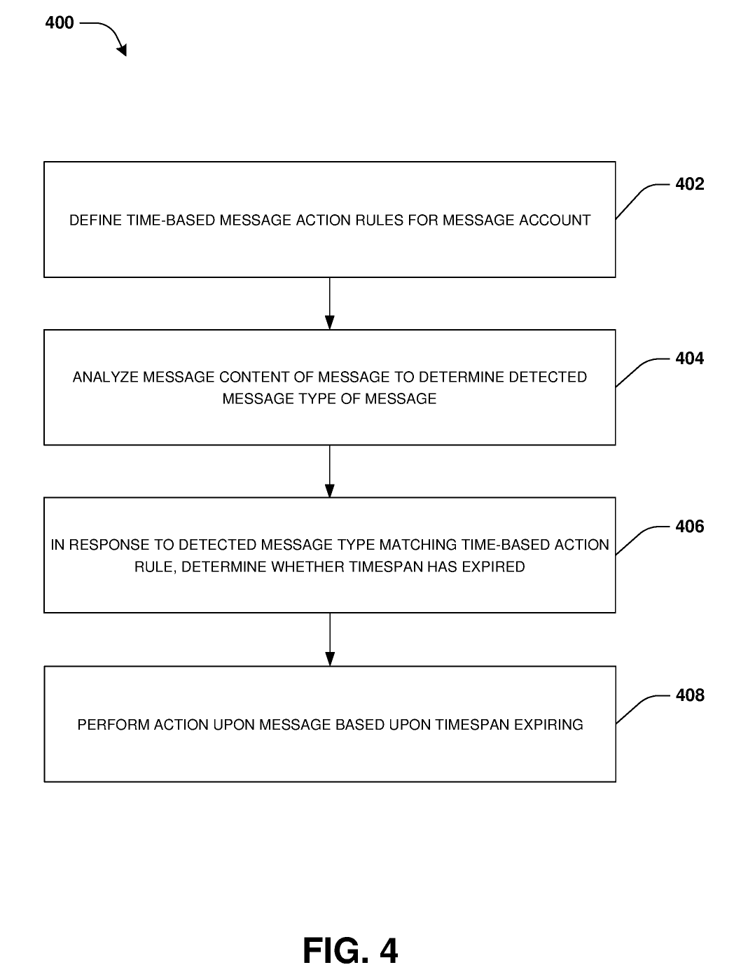

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or message clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., a message address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### Presented Techniques

Systems and/or techniques for time-based message actions are provided. The disclosed techniques implement a message system that provides for automatically deleting irrelevant messages, such as those containing expired one-time passcodes (OTPs), password reset requests, sign-in attempt notifications, expired coupons, and time-sensitive content. The disclosed techniques may be implemented for any type of communication system and/or type of communication such as emails, text messages, instant messages, multimedia messages, social media messages, audio messages, video messages, or any other form of communication.

The message system allows both users and senders to manage message expiration and deletion through the implementation of user-defined rules and filters. The message system employs machine learning algorithms to analyze message content and identify specific message types (e.g., one-time passwords, password reset messages, coupons, etc.) based upon keywords (e.g., “coupon,” “password,” “expiration,” “limited time,” etc.), patterns, and sending information (e.g., whether the sender is an individual, a business, a particular type of business, etc.). The message system performs expiration date detection by extracting expiration dates and times from message content using natural language processing and/or regular expressions. If an explicit expiration (e.g., “this coupon expires in one week”) is not identified, then the message system predicts an expiration based upon the message type of the message (e.g., a typical timespan during which a one-time password is valid).

A user may define and customize the rules and filters used by the message system. The user may define message types of messages that are to be monitored for determining whether automated actions are to be performed upon the messages. The user may define time-based message action rules for deleting expired messages, such as where one-time password messages are deleted after 24 hours, password reset messages are deleted after 1 hour, etc. The user may specify that a message is to be moved to a designated folder before permanent deletion (e.g., a message is moved to an expired items folder for 5 days before permanent deletion). The user may define sender-specific rules such as where promotional messages from a specific sender are to be deleted after 9 days.

The message system may implement sender-defined expirations. In particular, the message system may support message header tagging by senders. A sender can add a custom message header tag specifying a desired expiration time for a message. The custom message header tag may be standardized to ensure compatibility with different message providers and/or message clients. The message system performs expiration time processing to recognize and interpret the custom message header tag within the message header to identify the desired expiration time for the message. In this way, the message system automatically deletes the message upon expiration of the sender specified expiration time set for the message.

In some embodiments, the message system may be integrated into a message client as a plugin or extension on a client device. In some embodiments, the message system may be implemented at a message server to process messages before they reach an inbox of a message account (e.g., the message server may tag messages with expiration dates upon which a message client will perform a designated action defined by the tag). In some embodiments, the message system may be hosted as a cloud-based service that provides time-based message actions across different message platforms, message accounts, and devices.

The message system may implement a scanner that performs a deletion process by periodically scanning a message folder (e.g., an inbox or other designated folder) for messages matching the defined rules and filters of the time-based message action rules. The deletion process performs an expiration identification process to identify an expiration date/time of each message. The deletion process automatically deletes, moves to a designated folder, or performs other actions with respect to expired messages based upon user preferences.

The message system may implement a user interface through which users can perform rule management by creating, modifying, and/or deleting time-based message action rules. Notifications and/or logs can be provided through the user interface about actions performed upon messages, such as a notification that a message was deleted or moved to a designated folder, or a log of deleted/moved messages for user review.

In addition, various embodiments of the present technology provide for a wide range of technical effects, advantages, and/or improvements to computing systems and components. For example, various embodiments may include one or more of the following technical effects, advantages, and/or improvements: 1) automatic removal of irrelevant and expired messages for keeping a message inbox automatically organized with reduced clutter; 2) improved message management that saves user time and effort through automated message cleanup; 3) enhanced security by reducing the risk of unauthorized access by deleting time-sensitive messages such as one-time passwords and password reset messages; 4) storage optimization by freeing storage space by removing unnecessary messages.

The message system provides for proactive expiration handling by supporting sender-defined expirations for messages. This empowers senders to set expiration dates on messages through a standardized header tag. This shifts some control of message lifespan to senders because the senders might have the best knowledge of when their messages become irrelevant, which is useful for time-sensitive communications such as promotions, event invitations, notifications, etc. A tag may specify an action to perform for a message after a particular date, such as to delete or more a message after 3 days.

The message system provides for intelligent message classification by utilizing machine learning for content analysis. The machine learning is used to identify message types (e.g., one-time password messages, password reset messages, coupon messages, etc.), which is more complex than simple keyword filtering. The machine learning is used to recognize patterns and context of messages (e.g., a message with text “you are invited to our Christmas party” may be evaluated to identify a context of a time sensitive event on/around Christmas that would expires after the Christmas season). This leads to more accurate message type classifications and automated actions, while reducing the need for users to create complex rules for each message type.

The message system provides prediction expiration functionality that estimates expirations for messages based upon the detected message types of the messages. An explicit expiration date may be identified from a message (e.g., a message with the text “hope you can join us on Wednesday for our one day sale”). Even if an explicit expiration date is not identified, the message system can intelligently predict an expiration timeframe based on the type of message (e.g., a one-time password may have a predicted expiration of an hour). Thus, the message system can manage messages that are time-sensitive, but lack clear expiration information.

The message system provides for flexible user controls with granular rule customization that gives users a high degree of control over how different message types are handled. Users can define specific timeframes, sender-based rules, and pre-deletion actions (e.g., moving an expired message to a specified folder for a certain amount of time before deletion, along with providing a notification of the expired message being moved). This provides flexibility that ensures the message system can adapt to individual preferences and requirements.

The message system provides for integration and accessibility. The message system may be integrated into a message client on a client device, implemented server side, or hosted as a separate cloud service. The message system may seamlessly integrate into an existing message infrastructure through a client-side plugin or server-side deployment, which maximizes compatibility and accessibility for users across message platforms. The message system provides an intelligent and user-centric approach to message management by automated deletion of irrelevant messages based upon user preference and/or sender input, which minimizes inbox clutter, enhances security, and saves user time and effort.

The message system reduces inbox clutter by automatically removing expired and irrelevant messages so that individuals can maintain a clean and organized inbox, which reduces stress and improves productivity. The message system save time for users that no longer need to manually sift through and delete outdated messages so that the users can focus on more important tasks. The message system improves security such as where time-sensitive messages (e.g., one-time password messages and password reset messages) are automatically deleted to minimize the risk of unauthorized access and improve overall security. Automatically filtering and deleted unnecessary messages provides a clutter-free inbox so users are not distracted by outdated information. The message system provides storage optimization by deleting unnecessary messages to free storage space. Many user accounts or devices have limited storage capacity, and thus conversation of storage space is important. The message system enhances performance by maintaining a smaller inbox size so that a client message interface/app/website can load faster and perform more efficiently, which saves network bandwidth and reduces overall costs for users. In this way, the message system provides peace of mind to individuals by automating the cleanup of irrelevant messages so that users do not accumulate digital clutter and miss important messages.

The message system reduces storage costs for organizations by deleting irrelevant messages to reduce storage otherwise consumed by message servers and cloud storage. The message system enhances security by minimizing the risk of security breaches of an organization by ensuring timely deletion of sensitive information such as internal communication, confidential data, time-limited access codes, and/or other message types. The message system improves compliances where organizations are regulated to comply with data retention policies and regulations by automatically deleting messages containing sensitive or confidential data, time-bound information, and/or other message types (e.g., a policy may specify that patient information must be retained in a read only state for 2 years, and then can be deleted). The message system automatically manages the lifecycle of promotional or other types of messages through the implementation of a sender-defined expiration feature to automatically remove messages once the messages become irrelevant. In this way, the message system provides a proactive and intelligent technical solution to message management that improves efficiency (e.g., automates message cleanup to save time and effort), organization (e.g., reduces inbox clutter and improves message management), security (e.g., enhances data security by deleting time-sensitive messages), productivity (e.g., reduces distractions from irrelevant message inbox clutter), and cost savings (e.g., optimizes storage space and reduces associated costs).

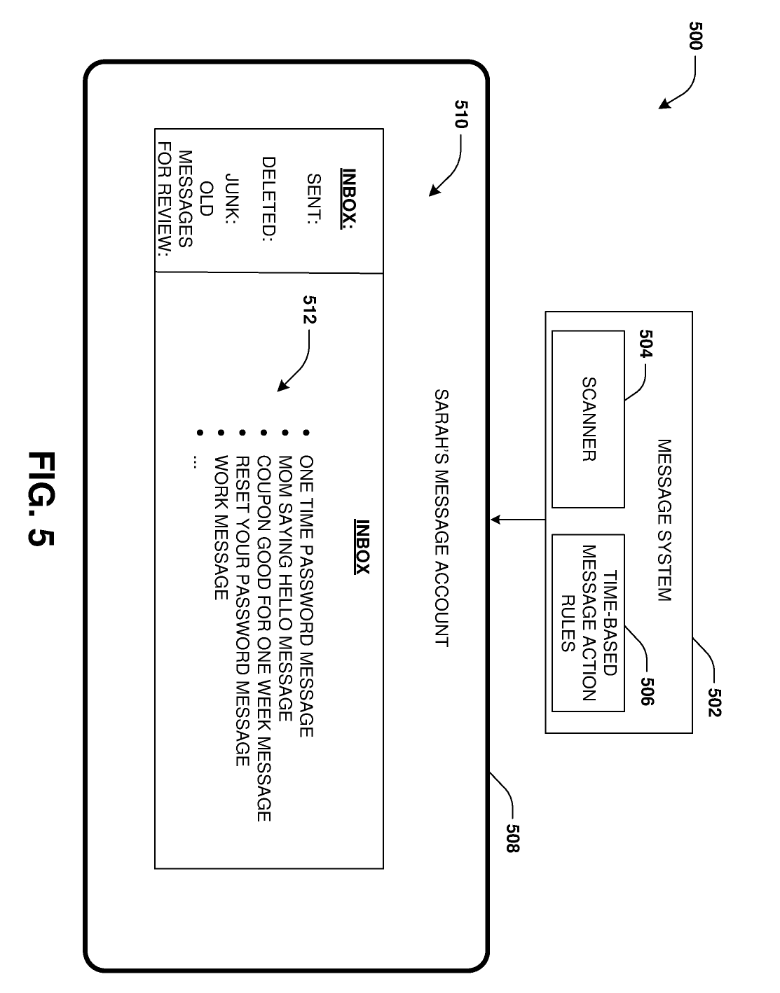

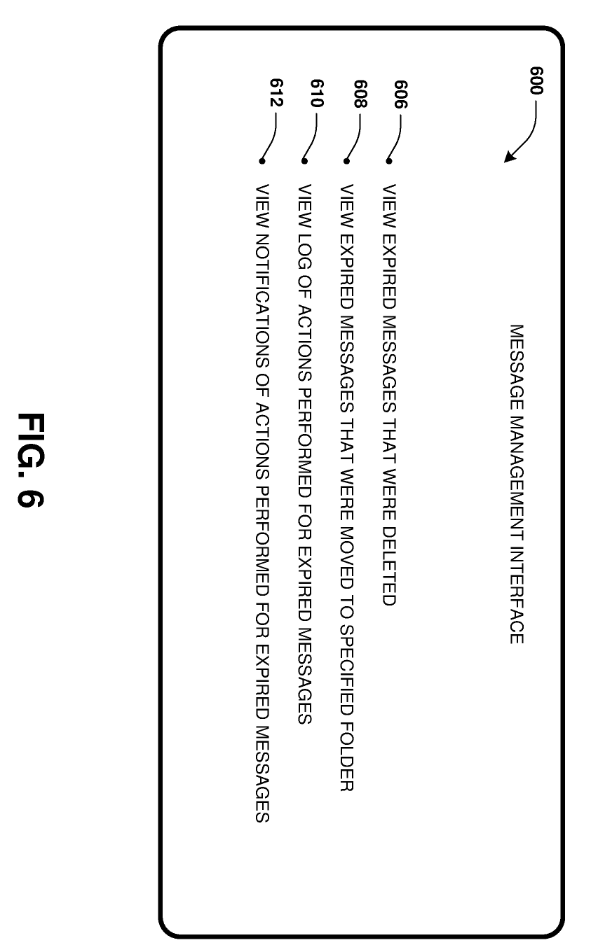

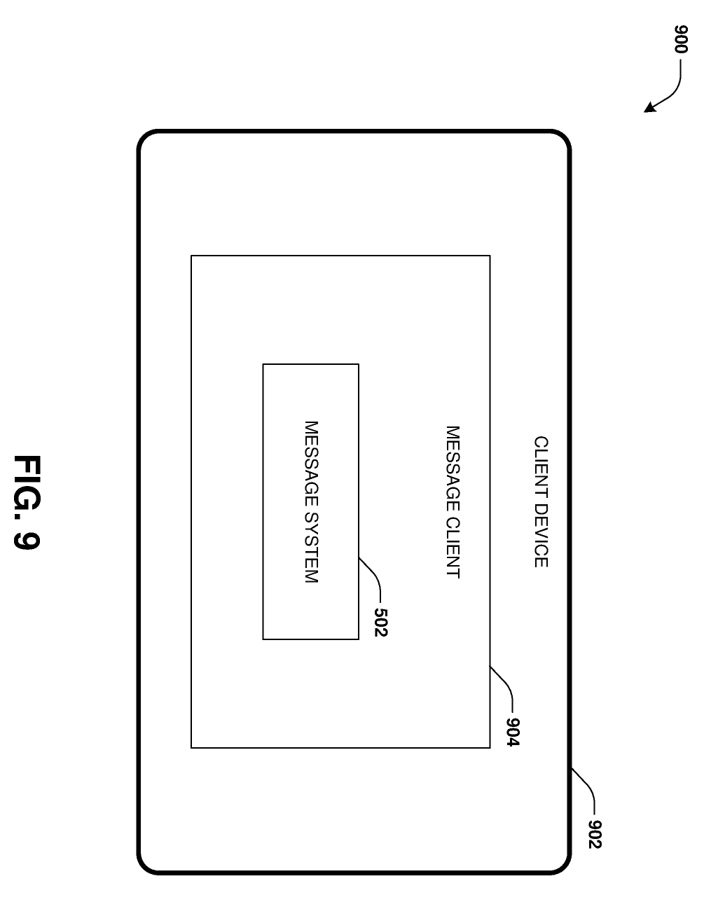

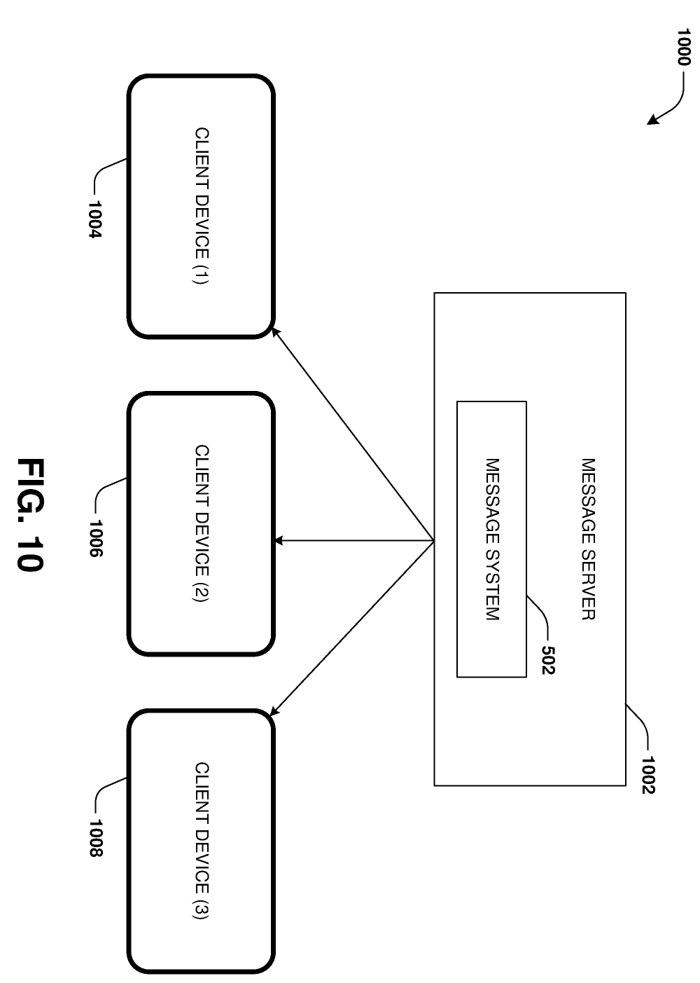

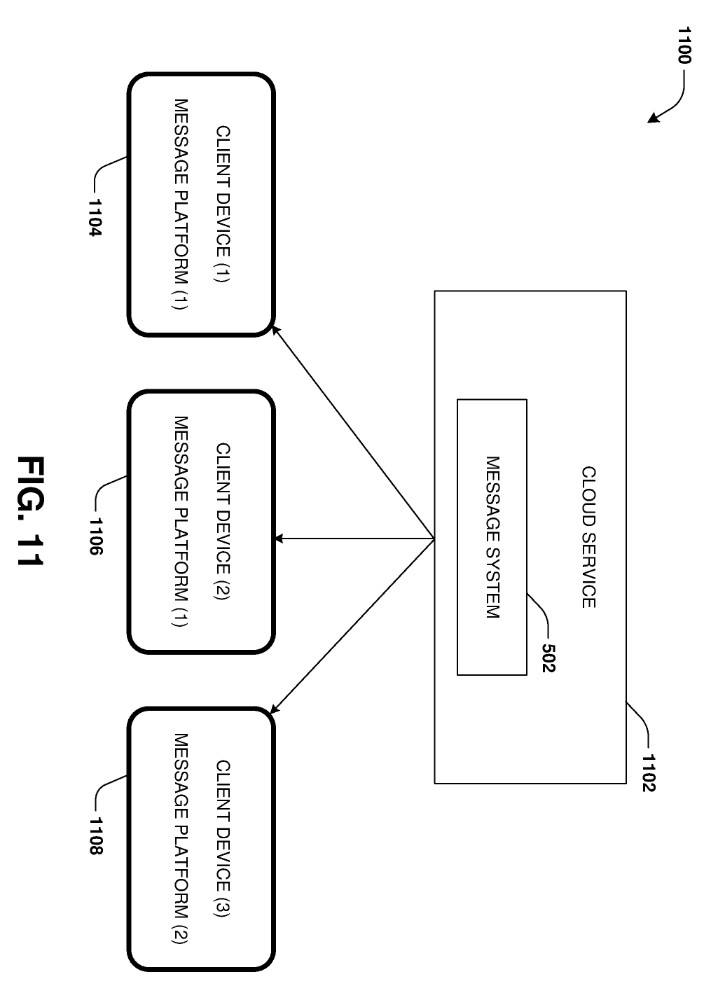

FIG. 4 is a flow chart illustrating an example method 400 for time-based message actions, which is described in conjunction with system 500 of FIG. 5. The system 500 may include a message system 502 that executes the method 400. In some embodiments, the message system 502 may be hosted at a message client of a client device, such as client device 508 being utilized by a user to access a message account 510, an example of which is illustrated by system 900 of FIG. 9 where the message system 502 is hosted by a message client 904 of a client device 902. For example, the message system 502 may be hosted as a plugin or extension integrated into the message client for implementing time-based action rules. In some embodiments, the message system 502 may be hosted by a message server to implement time-based action rules before messages are delivered to an inbox of a message account (e.g., if an expiration time is identified for a message, then the message will be tagged for automatic deletion based upon the expiration time), an example of which is illustrated by system 1000 of FIG. 10 where the message system 502 is hosted by a message service 1002 for implementing the time-based action rules for a first client device 1004, a second client device 1006, a third client device 1008, etc. In some embodiments, the message system 502 may be hosted by a cloud-based service for users across different message platforms and devices, an example of which is illustrated by system 1100 of FIG. 11 where the message system 502 is hosted by a cloud service 1102 for implementing the time-based action rules for a first client device 1104 and a second client device 1106 using a first message platform/provider and a third client device 1108 using a second message platform/provider.

The message system 502 may implement time-based message action rules 506 for identifying and performing time-based actions for messages such as through the implementation of a scanner 504. In some embodiments, the time-based message action rules 506 are preconfigured for the message system 502. In some embodiments, the time-based message action rules 506 are user defined, such as through a user interface. During operation 402 of method 400, the time-based message action rules are defined for the message account 510 being accessed through the client device 508. A time-based action rule may specify an action to perform upon messages, having a message type, after expiration of a timespan. In an example, a user may set a time-based action rule to delete all one-time password messages after 1 hour. In an example, a user may set a time-based action rule to move expired coupons to an expired offers folder for future reference/review before permanent deletion, such as manual deletion by the user or automated deletion from the expired offers folder after a particular timespan such as 4 days. The time-based message action rules 506 may be defined for various message types, such as one-time passcode messages, password reset request messages, sign-in attempt notification messages, expired promotion messages, confidential or internal messages, external messages, messages from a particular sender, and/or time-sensitive messages. In some embodiments, different timespans may be defined for different message types, such as where password reset request messages are to be deleted after 45 minutes and expired event messages are to be deleted 4 days after the occurrence of the events (e.g., a message about a concert is to be deleted 4 days after the concert).

During operation 404 of method 400, the message system 502 may analyze message content of messages associated with the message account 510 to determine detected message types of the messages, such as messages 512 within an inbox. In some embodiments, the message system 502 may execute a machine learning algorithm to analyze message content of a message based upon keywords, sender information, and/or patterns to determine a detected message type for a message (e.g., keywords such as “coupon,” “limited time,” “expiring soon,” “password,” “for this week only,” etc.; patterns of how long users retain a certain type of message before that type of message is deleted by the users; or a sender that routinely sends promotional coupons that expire).

If a detected message type of a message matches a message type of a time-based action rule, then an expiration for the message may be determined and compared to a timespan indicating that an action is to be performed for expired messages once the timespan has expired, during operation 406 of method 400. The message system 502 may evaluate the message content to extract information related to an expiration for the message. In response to the information specifying an explicit expiration for the message (e.g., “this coupon expires in 5 days”), then the timespan is set based upon the explicit expiration (e.g., the timespan is set to 5 days after the message has received, after which the message is deemed to be expired and an action is to be performed upon the message). If there is no explicit expiration, then an expiration may be predicted for the message based upon the message type to create a predicted expiration used to set the timespan (e.g., prediction expirations may be set for 1 hour for password reset message types).

During operation 408 of method 400, an action is performed upon the message based upon the timespan expiring. The action may include deleting the message, moving the message to a specified message folder, marking the message for subsequent deletion at a determined date (e.g., the message may be moved to an expired offers folder and deleted within 7 days of being moved to the expired offers folder), generating a notification about the message, deleting the message and generating a deletion notification that the message has been deleted, deleting the message and generating a log entry that the message has been deleted, moving the message to a specified message folder and generating a notification that the message was moved, etc. In this way, an action or sequence of actions may be performed for an expired message (e.g., moving an expired message to an expired message folder, send a notification of the expired message being moved, delete the expired message from the expired message folder after 4 days, and creating a log entry of the expired message being deleted from the expired message folder).

In some embodiments, the message system 502 may evaluate a message to determine whether the message is tagged with a message header tag by a sender of the message. The message header tag may include a sender specified expiration for the message and action to be performed upon the message upon expiration of the sender specified expiration. For example, the message is to be moved to a junk folder within 20 hours and/or deleted in 38 hours (e.g., moved to the junk folder in 20 hours, and then deleted 18 hours after being moved to the junk folder). In this way, a particular action (or sequence of actions) may be performed upon the message based upon the message header tag. In an example, a sender may tag a promotional message with a 7-day expiration, after which it is automatically deleted from recipients' inboxes.

In some embodiments, the scanner 504 may be executed to scan a message folder for messages matching the time-based message action rules. The scanner 504 is executed to evaluate expirations for the messages to identify expired messages. Actions may be performed upon the expired messages, such as where the expired messages are deleted or moved to a particular folder.

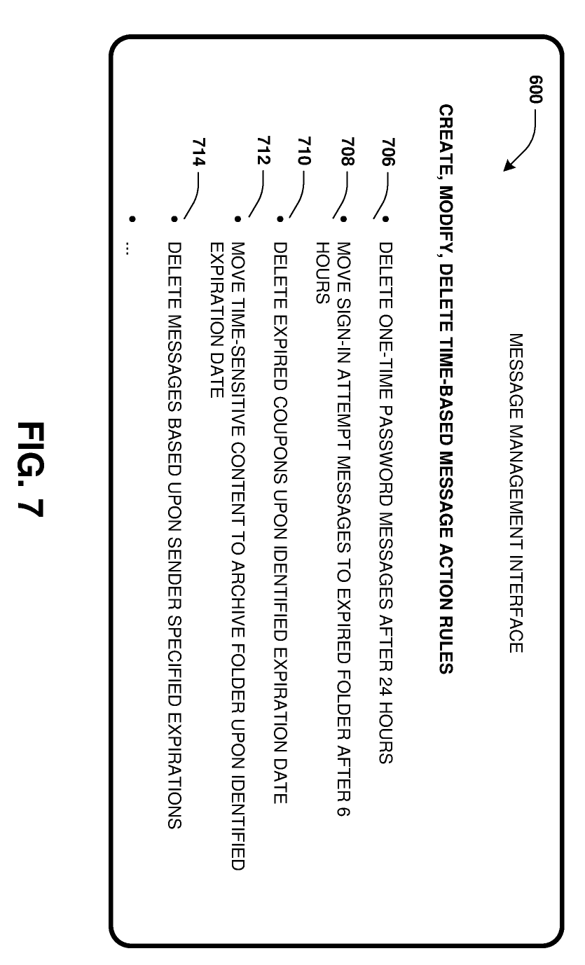

In some embodiments, a user interface is provided such as a message management interface 600 of FIG. 6. The message management interface 600 may provide users with the ability to view 606 expired messages that were deleted, view 608 expired messages that were moved to a specified folder, view 610 a log of actions performed for expired messages, and/or view 612 notifications of actions performed for expired messages.

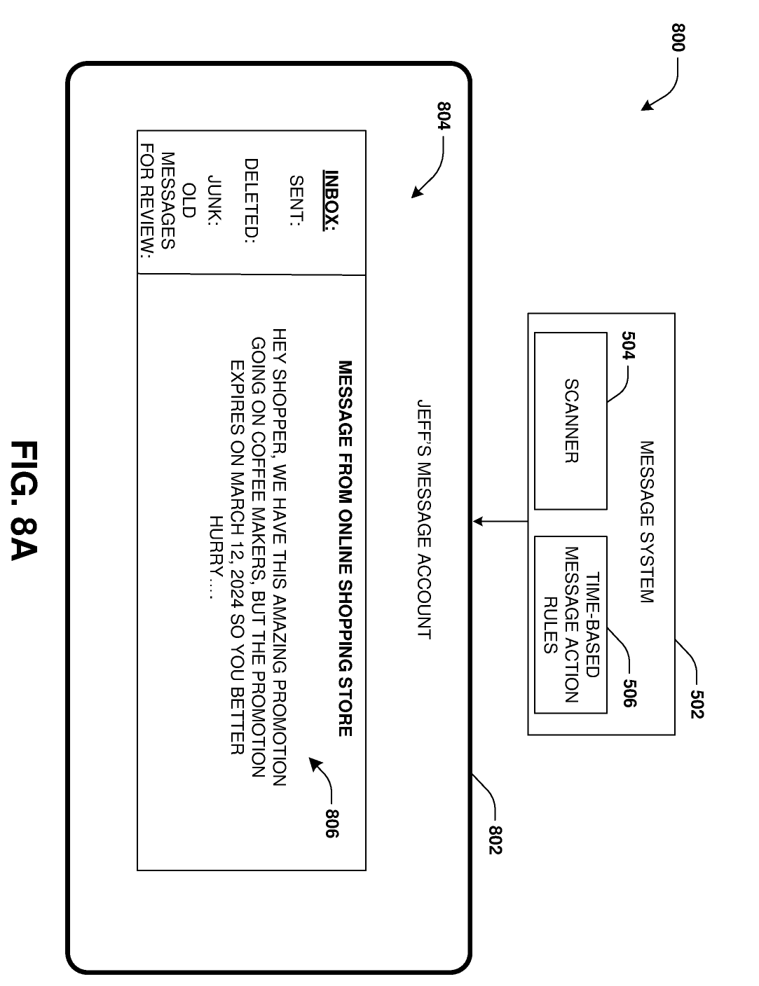

In some embodiments, the message management interface 600 may provide users with the ability to create, modify, and/or delete time-based message action rules, as illustrated by FIG. 7. The message management interface 600 may provide users with the ability to define time-based message action rules to delete or move messages, from a specified sender, after a defined timespan. The message management interface 600 may provide users with the ability to define time-based message action rules to delete or move messages, having a specified message type, after a defined timespan. In an example, a user may define a time-based message action rule 706 where one-time password messages are to be deleted after 24 hours. In an example, a user may define a time-based message action rule 708 where sign-in attempt messages are moved to an expired folder after 6 hours. In an example, a user may define a time-based message action rule 710 where expired coupon messages are deleted upon expiration dates identified within the expired coupon messages. In an example, a user may define a time-based message action rule 712 where time-sensitive content is moved to an archive folder upon an identified expiration date. In an example, a user may define a time-based message action rule 714 where messages are deleted based upon sender specified expirations within message header tags.

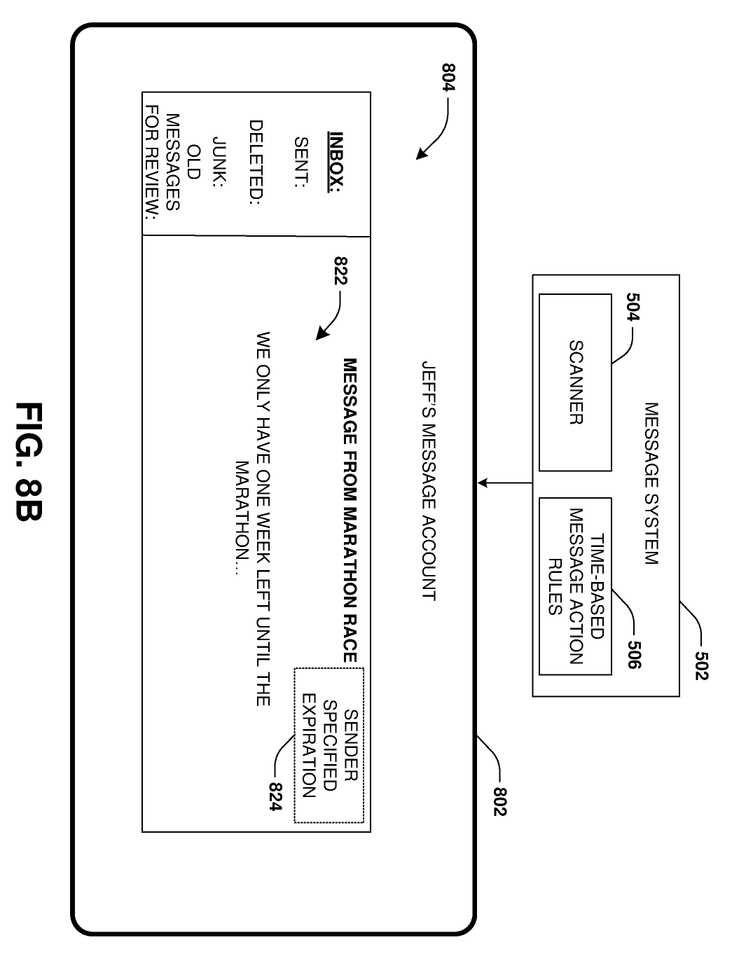

FIG. 8A is a component block diagram illustrating an example system 800 implementing a time-based message action for a message. The system 800 may utilize the message system 502 to evaluate a message 806 of a message account 804 being accessed by a client device 802. The message 806 may be from an online shopping store, and includes a promotion that expires on March 12, 2024. The message system 502 may evaluate the text of the message 806 to detect an expiration of March 12, 2024 and determine that the message has a promotion message type. The promotional message type may match a time-based message action rule specifying that promotional messages are to be moved to an old messages for review folder 3 days after a promotion expires. Accordingly, the message system 502 may move the message 806 into the old messages for review folder on or after March 15, 2024.

The system 800 may utilize the message system 502 to evaluate a message 822 from a sender, such as a marathon race coordinator, as illustrated by FIG. 8B. The message 822 may discuss how a marathon race will occur in one week. The sender may have tagged the message 822 with a tag 824 that includes a sender specified expiration (e.g., an instruction to delete the message 822 after 9 days from receipt). Accordingly, the message system 502 will delete the message 822 after 9 days of the message 822 being received.

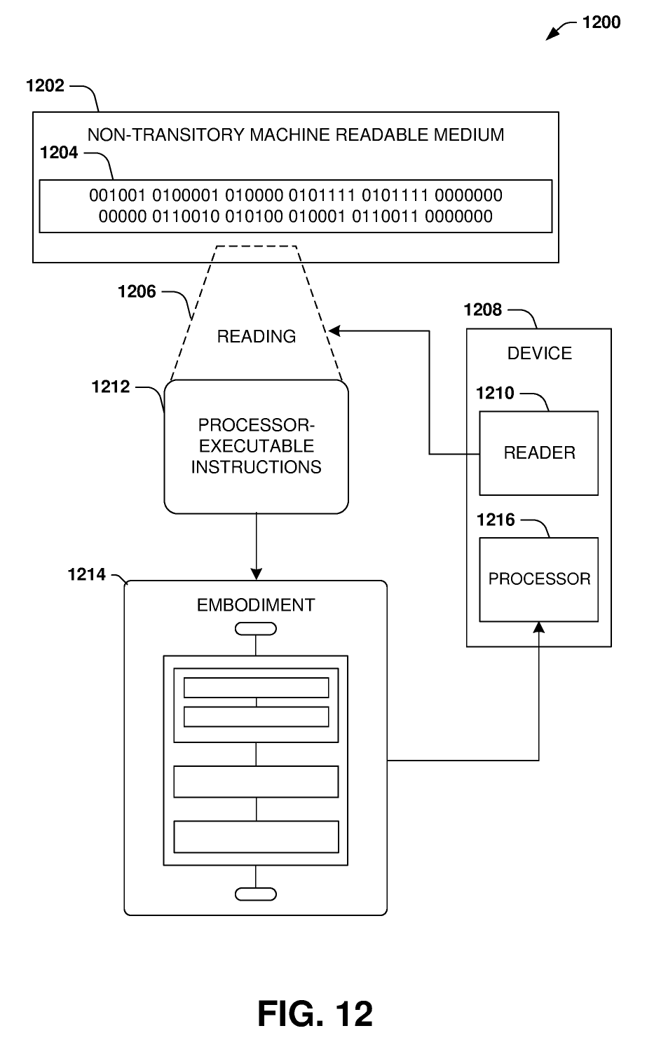

FIG. 12 is an illustration of a scenario 1200 involving an example non-transitory machine readable medium 1202. The non-transitory machine readable medium 1202 may comprise processor-executable instructions 1212 that when executed by a processor 1216 cause performance (e.g., by the processor 1216) of at least some of the provisions herein (e.g., embodiment 1214). The non-transitory machine readable medium 1202 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 1202 stores computer-readable data 1204 that, when subjected to reading 1206 by a reader 1210 of a device 1208 (e.g., a read head of a hard disk drive, or a read operation invoked on a solid-state storage device), express the processor-executable instructions 1212. In some embodiments, the processor-executable instructions 1212, when executed, cause performance of operations, such as at least some of the example method 400 of FIG. 4, for example. In some embodiments, the processor-executable instructions 1212 are configured to cause implementation of a system, such as at least some of the example system 500 of FIG. 5, for example.

### Usage of Terms

As used in this application, "component," "module," "system", "interface", and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, "example" is used herein to mean serving as an instance, illustration, etc., and not necessarily as advantageous. As used herein, "or" is intended to mean an inclusive "or" rather than an exclusive "or". In addition, "a" and "an" as used in this application are generally be construed to mean "one or more" unless specified otherwise or clear from context to be directed to a singular form. Also, at least one of A and B and/or the like generally means A or B or both A and B. Furthermore, to the extent that "includes", "having", "has", "with", and/or variants thereof are used in either the detailed description or the claims, such terms are intended to be inclusive in a manner similar to the term "comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
defining time-based message action rules for a message account, wherein a time-based action rule specifies that an action is to be performed upon messages, having a message type, after expiration of a timespan;
analyzing message content of a message associated with the message account to determine a detected message type of the message;
in response to the detected message type of the message matching the message type of the time-based action rule, determining whether the timespan has expired for the message; and
performing the action upon the message based upon the timespan expiring.

2. The method of claim 1, wherein the analyzing message content comprises:
executing a machine learning algorithm to analyze the message content based upon keywords, sender information, and patterns to determine the detected message type.

3. The method of claim 1, comprising:
evaluating the message content to extract information related to an expiration for the message; and
in response to the information specifying an explicit expiration for the message, setting the timespan based upon the explicit expiration.

4. The method of claim 1, comprising:
evaluating the message content to extract information related to an expiration for the message;
in response to not identifying an explicit expiration for the message in the information, predicting the expiration for the message based upon the message type as a predicted expiration; and
setting the timespan based upon the predicted expiration.

5. The method of claim 1, wherein the action comprises at least one of deleting the message, moving the message to a specified message folder, marking the message for deletion at a determined date, generating a notification about the message, deleting the message and generating a deletion notification that the message has been deleted, or deleting the message and generating a log entry that the message has been deleted.

6. The method of claim 1, comprising:
evaluating the message content to identify a message header tag specified by a sender of the message;
extracting an expiration for the message from the message header tag as a sender specified expiration; and
determining when to perform the action for the message based upon the sender specified expiration.

7. The method of claim 1, comprising:
implementing the time-based action rules by a plugin or extension integrated into a message client for the message account.

8. The method of claim 1, comprising:
implementing the time-based action rules by a message server before messages are delivered to an inbox of the message account.

9. The method of claim 1, comprising:
implementing time-based action rules by a cloud-based service for users across different message platforms and devices.

10. A non-transitory machine-readable medium having stored thereon processor-executable instructions that when executed cause performance of operations comprising:
defining time-based message action rules for a message account, wherein a time-based action rule specifies that an action is to be performed upon messages, having a message type, after expiration of a timespan;
analyzing message content of a message associated with the message account to determine a detected message type of the message;
in response to the detected message type of the message matching the message type of the time-based action rule, determining whether the timespan has expired for the message; and
performing the action upon the message based upon the timespan expiring.

11. The non-transitory machine-readable medium of claim 10, the operations comprising:
implementing a scanner to scan a message folder for messages matching the time-based message action rules.

12. The non-transitory machine-readable medium of claim 11, the operations comprising:
evaluating expirations for messages identified by the scanner to identify expired messages; and
performing actions upon the expired messages to either delete the expired messages or move the expired messages to a designated folder.

13. The non-transitory machine-readable medium of claim 10, the operations comprising:
defining time-based message action rules for message types including at least one of a one-time passcode message, a password reset request message, a sign-in attempt notification message, an expired promotion message, a confidential message, or a time-sensitive message.

14. The non-transitory machine-readable medium of claim 10, the operations comprising:
defining a first timespan for a first message type and a second timespan for a second message type, wherein the first timespan is different than the second timespan.

15. A computing device comprising:
a processor; and
memory comprising processor-executable instructions that when executed by the processor cause performance of operations comprising:
defining time-based message action rules for a message account, wherein a time-based action rule specifies that an action is to be performed upon messages, having a message type, after expiration of a timespan;
analyzing message content of a message associated with the message account to determine a detected message type of the message;
in response to the detected message type of the message matching the message type of the time-based action rule, determining whether the timespan has expired for the message; and
performing the action upon the message based upon the timespan expiring.

16. The computing device of claim 15, the operations comprising:
displaying a user interface providing functionality for a user to create, modify, and delete the time-based message action rules.

17. The computing device of claim 16, the operations comprising:
providing, through the user interface, access to a log of deleted messages for user review.

18. The computing device of claim 16, the operations comprising:
receiving, through the user interface, a user defined time-based message action rule to delete messages, having a specified message type, after a defined timespan.

19. The computing device of claim 16, the operations comprising:
receiving, through the user interface, a user defined time-based message action rule to move messages to a designated folder, having a specified message type, after a defined timespan.

20. The computing device of claim 15, the operations comprising:
receiving, through the user interface, a user defined time-based message action rule to delete messages, from a specified sender, after a defined timespan.
